(19) United States
(12) Patent Application Publication
(10) Pub. No.: US 2006/0100000 A1
(43) Pub. Date: May 11, 2006

(54) System and method for dynamic power savings for short range wireless systems

(75) Inventors: Robert A. Marples, Coral Springs, FL (US); Mayra Zayas, Pembroke Pines, FL (US)

Correspondence Address: AKERMAN SENTERFITT, P.O. BOX 3188, WEST PALM BEACH, FL, 33402-3188, US

(73) Assignee: Motorola, Inc., Schaumburg, IL (US)

(21) Appl. No.: 10/982,473

(22) Filed: Nov. 5, 2004

(51) Int. Cl. H04B 1/38

(52) U.S. Cl. 455/574

(57) ABSTRACT

A method (100) and system (11) of dynamic power savings for a shorter range wireless connection based on service conditions for a longer range wireless connection can include the monitoring (102) a latency requirement for the longer range wireless connection based on service conditions and dynamically modifying (104) a reconnect time for the shorter range wireless connection with a change in the latency requirement for the longer range wireless connection based on change in service conditions. The latency requirement for the longer range wireless connection can be based on changes in communication modes for the longer range wireless connection. The communication modes can be a dispatch audio mode, an interconnect audio mode, or an out of service mode for example. The step of dynamically modifying the reconnect time can optionally include adjusting (106) the reconnect time as service conditions change to meet a most critical timing to be encountered.

### FIELD OF THE INVENTION

This invention relates generally to power saving techniques, and more particularly to a method and system for power saving when using a short range communication link.

### BACKGROUND OF THE INVENTION

The existing Bluetooth protocol for short range wireless connections has a power savings scheme that is suitable for most one dimensional devices that have one primary function with limited battery life. Most devices using the Bluetooth protocol are small portable devices such as cellular phones that have one primary function. As multiple technologies (cellular, dispatch radio, messaging, cameras, video, personal digital assistants, laptops, etc.) converge into a single device, the current methods of power savings used in Bluetooth (sniff, park, hold) and possibly other short range wireless protocols fail to adjust to the expected use patterns of these multi-dimensional products that will be available in the foreseeable future.

Although Bluetooth radios are very low power, drawing as little as 0.3 mA in standby mode and 30 mA during sustained data transmissions and further alternates among power-saving modes in which device activity is lowered to maximize the mobile power supply, there still exists a need to extend the battery life of these multi-dimensional devices even further. In “hold” mode, whenever a master or slave in Bluetooth wishes, a hold mode can be established during which no data is transmitted. The purpose of this is to conserve power. Otherwise, there is a constant data exchange. A typical reason for going into hold mode is the connection of several piconets. In a “sniff” mode, applicable only to slave units, the slave does not take an active role in the piconet, but listens at a reduced level. This is usually a programmable setting. The “park” mode is a more reduced level of activity than the hold mode. During park mode, the slave is synchronized to the piconet, thus not requiring full reactivation, but is not part of the traffic. In this state, they do not have MAC addresses, but only listen enough to keep their synchronization with the master and check for broadcast messages.

The park, sniff, and hold technique and other techniques used by current short range wireless protocols do not adequately extend battery life because the timing of these power savings modes are set to meet the most critical timing scenario encounterable by the device. The existing power saving techniques fail to take into account that the most critical timing scenario encounterable can change based on service or connection conditions. Thus, with additional devices including more and more multiple functions, the critical timing scenario will more than likely continue to change more significantly and leaving many missed opportunities for further power savings.

### SUMMARY OF THE INVENTION

Embodiments in accordance with the present invention can provide a system and method for suitably adjusting a reconnect time for a shorter range wireless connection based on the most critical timing scenario that a device will encounter. In this manner, additional power savings can be had over techniques that overlook changes in service conditions or other operating conditions.

In a first embodiment of the present invention, a method of dynamic power savings for a shorter range wireless connection based on service conditions for a longer range wireless connection can include the steps of monitoring a latency requirement for the longer range wireless connection based on service conditions and dynamically modifying a reconnect time for the shorter range wireless connection with a change in the latency requirement for the longer range wireless connection based on change in service conditions. The step of monitoring the latency requirement for the longer range wireless connection can be based on changes in communication modes for the longer range wireless connection. The communication modes can be a dispatch audio mode, an interconnect audio mode, or an out of service mode for example. The step of dynamically modifying the reconnect time can include adjusting the reconnect time as service conditions change to meet a most critical timing to be encountered.

In a second embodiment of the present invention, a system for dynamic power savings for a communication device having a shorter range wireless connection and a longer range wireless connection based on service conditions for the longer range wireless connection can include comprising a transceiver for at least one among the shorter range wireless connection and the longer range wireless connection and a processor coupled to the transceiver. The processor can be programmed to monitor a latency requirement for the longer range wireless connection based on service conditions and dynamically modify a reconnect time for the shorter range wireless connection with a change in the latency requirement for the longer range wireless connection based on change in service conditions. The processor can monitor the latency requirement for the longer range wireless connection based on changes in communication modes for the longer range wireless connection where the communication modes can be for example a dispatch audio mode, an interconnect audio mode, and an out of service mode. The processor can also dynamically modify the reconnect time by adjusting the reconnect time as service conditions change to meet a most critical timing to be encountered by the longer range wireless connection. The shorter range wireless connection can be for example a Bluetooth connection, a 802.11a-g connection, or wireless local area network. The longer range wireless connection can be for example a two-way messaging system, a cellular radio system, a satellite communication system, a dispatch radio system, or a two-way trunked radio system.

In a third embodiment of the present invention, a system for dynamic power savings for a portable electronic device having a wireless connection to a second electronic device can include a first transceiver in the portable electronic device in communication with a second transceiver in the second electronic device and a processor coupled to the first transceiver. The processor can be programmed to monitor a latency requirement in the second device corresponding to an expectation of needing a future data link between the portable electronic device and the second electronic device and dynamically modify a reconnect time between the portable electronic device and the second electronic device with a change in the latency requirement for the second electronic device based on a change in application status at the second electronic device. The processor can monitor the latency requirement for the second electronic device based on changes in application status such as communication modes for the second electronic device. The communication modes can be for example a dispatch audio mode, an interconnect audio mode, or an out of service mode.

The change in application status further can include a change from having no applications open to having at least one application open at the second electronic device. Alternatively, the change in application status can further include a change from having one application active with a first latency requirement to having another application active with a second latency requirement at the second electronic device. Note, the processor can dynamically modify the reconnect time by adjusting the reconnect time as service conditions change to meet a most critical timing to be encountered by the second electronic device. As noted above, the portable electronic device can be a Bluetooth transceiver, 802.11a-g based transceiver, or a wireless local area network transceiver and the second electronic device can be a two-way messaging device, a cellular radio device, a satellite communication device, a dispatch radio device, or a two-way trunked radio device. Optionally, the second electronic device can be a laptop computer, a desktop computer, a personal digital assistant, a copier, a printer, a facsimile machine, and a wired telephone, and a television tuner.

Other embodiments, when configured in accordance with the inventive arrangements disclosed herein, can include a system for performing and a machine readable storage for causing a machine to perform the various processes and methods disclosed herein.

### BRIEF DESCRIPTION OF THE DRAWINGS

FIG. 1 is a block diagram of a system for dynamic power savings for a communication device having a shorter range wireless connection and a longer range wireless connection in accordance with an embodiment of the present invention.

FIG. 2 is a timing diagram illustrating how a reconnect time for a shorter range wireless connection can be dynamically adjusted in accordance with an embodiment of the present invention.

FIG. 3 is a flow chart illustrating a method of dynamic power savings for a portable device having a shorter range wireless connection in accordance with an embodiment of the present invention.

### DETAILED DESCRIPTION OF THE DRAWINGS

While the specification concludes with claims defining the features of embodiments of the invention that are regarded as novel, it is believed that the invention will be better understood from a consideration of the following description in conjunction with the figures, in which like reference numerals are carried forward.

As noted above, existing methods of Bluetooth power saving (such as sniff, park and hold) shut down the connection between two devices temporarily and reconnect at fixed regular intervals to see if an active connection is needed. In the interval between checking, the devices cannot communicate. Therefore, it is common practice to set the interval for connection checks to be smaller than the most critical timing scenario encounterable between the devices to guarantee that the connection can be ready and no data is lost. When implemented in a device having multiple functions having different service requirements, the critical timing scenario encountered can change from time to time. Currently, existing systems miss the opportunity save further power by adjusting the interval for reconnecting based on service conditions. The current methodology sets a single time for connection checks based on the shortest latency period. Here, embodiments of the present invention use the information available to a device to dynamically modify the connection check period. This scheme reduces the impact of low or short latency connection types by identifying cases when the lowest or shortest latency scenarios are not possible.

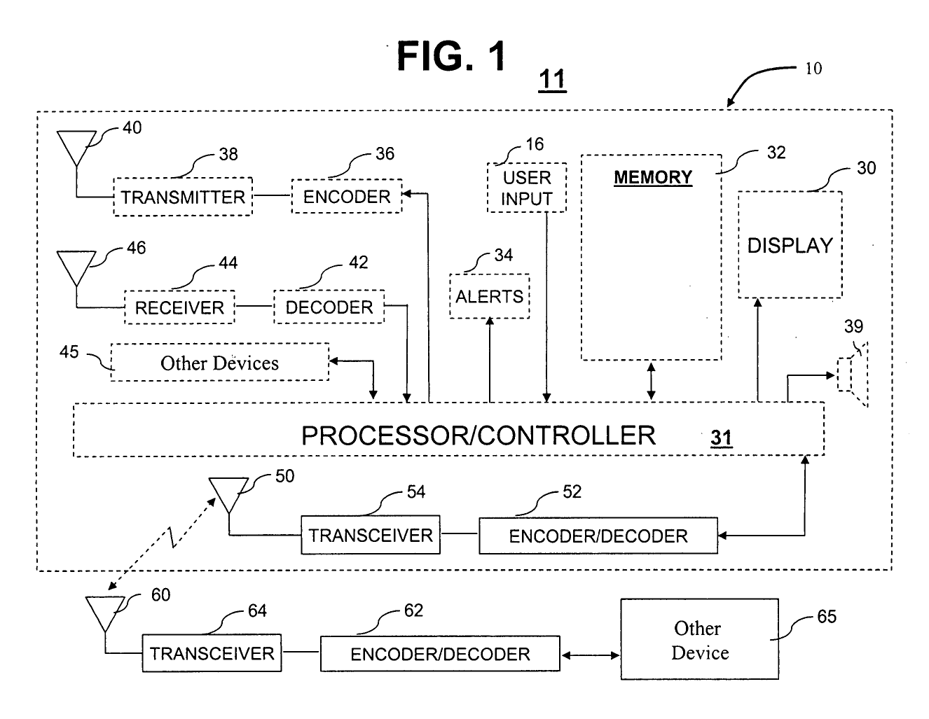

Opportunities for additional power savings abound in devices with multiple functions having varying critical timing. One example (among many) is a multi-mode phone having cellular and dispatch radio services. Referring to FIG. 1, a block diagram of a system 11 and a portable communication device 10 can include a conventional cellular phone, a two-way trunked radio, a combination cellular phone and personal digital assistant, a smart phone, a home cordless phone, a satellite phone, a lap top computer, or any combination thereof having an optional display or other user interface features in accordance with embodiments of the present invention. In this particular embodiment, the portable communication device 10 can include an encoder 36, transmitter 38 and antenna 40 for encoding and transmitting information as well as an antenna 46, receiver 44 and decoder 42 for receiving and decoding information sent to the portable communication device 10. The transmitter 38 and receiver 44 can form part of a longer range communication device for providing cellular service, dispatch radio service, satellite radio service, two-way messaging, or other known types of long range communication services. The device 10 can further include an alert 34, memory 32, a user input device 16 (such as a keyboard, mouse, voice recognition program, etc.), a speaker or annunciator 39, and a display 30 for displaying a graphical user interface (GUI) for example. The device 10 can further include a processor or controller 31 coupled to the display 30, the encoder 36, the decoder 42, the alert 34, the user input 16 and the memory 32. The memory 32 can include address memory, message memory, and memory for database information or for applications commonly found in cellular phones or other communication devices. Such applications can reside in external memory (32) or in internal memory within a portion of the processor 31. For example, the memory can include a database or one or more look-up tables that contain identifiers such as phone numbers, dispatch identifiers, mobile internet protocol addresses, instant messaging user identifiers, electronic mail addresses, or other identifiers associated with one or more applications or services.

Referring once again to FIG. 1, the system 11 can further include a short range wireless communication link in the form of an antenna 50, transceiver 54, and encoder/decoder 52 within the portable communication device 10 in communication with an external (of the portable communication device 10) device 65 via an antenna 60, transceiver 64, and encoder/decoder 62. Further note, that portable communication device 10 can include other devices 45 since embodiments of the present invention are not necessarily limited to portable communication devices that have longer range communication. “Other devices” 45 can range from simple computing devices such as personal digital assistants to laptop computer to personal hygiene devices or home appliances that can be in communication with the external communication device 65 via a short range communication link such a Bluetooth connection.

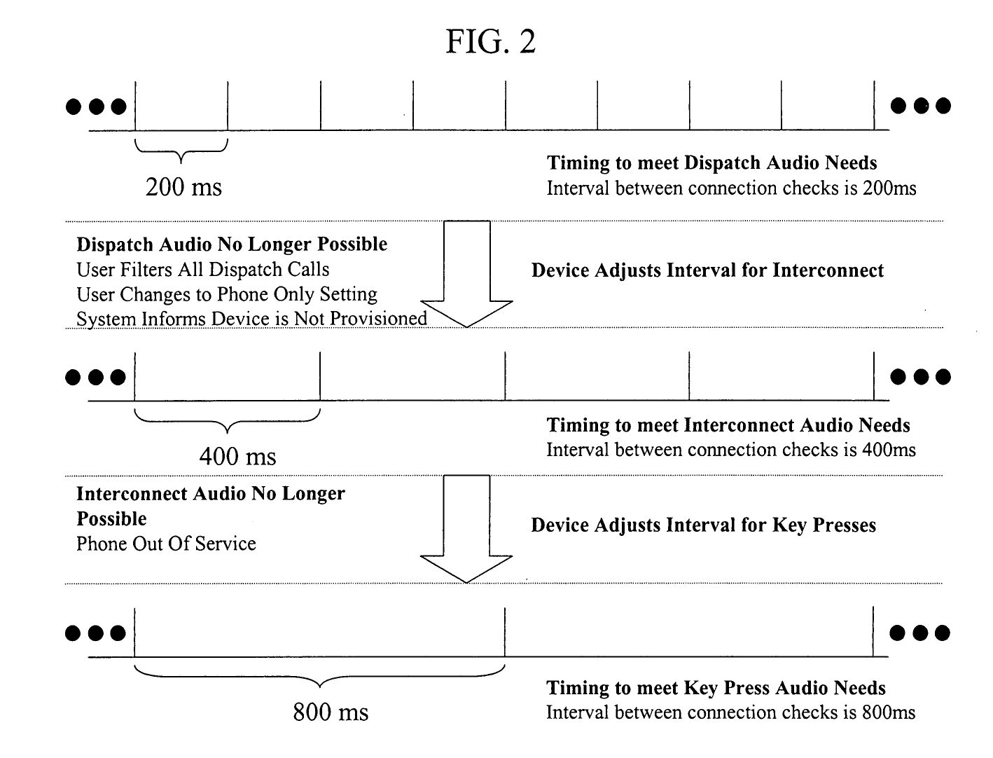

With reference to FIGS. 1 and 2, a more specific and illustrative example can include a combination dispatch radio and cellular or interconnect radio such as Motorola's iDEN phones. In an iDEN phone, the dispatch mode usually has the shortest critical timing, then interconnect mode, and then an out-of-service mode might have the longest critical timing requirements. The time available to route audio in dispatch mode without impacting a user's experience in an iDEN phone is approximately 400 millisecs in one example. Assuming the time to initiate play and routing of audio is 100 millisecs and the time to reestablish a connection is 100 millisecs, then the time between checking on a shorter range connection can be around 200 millisecs. Therefore, connected devices that expect dispatch audio will need to check for reconnection every 200 millisecs or risk losing dispatch audio. If the dispatch audio is disabled for one reason or another, the iDEN phone will unnecessarily check for a reconnection at shorter intervals using existing techniques. In accordance with an embodiment of the invention, the reconnect time can be adjusted as service conditions change to meet the most critical timing that can be encountered by the phone. In the abstract, this means that if time A is the most critical time, then the check happens every time A period. If the device enters a condition where events don't happen in time A but instead happen in time B (where A is less than or equal to B), then the connection check time is modified to a period equal to time B.

To continue with the example above, a device that needs to support dispatch audio might normally check every 200 millisecs although the device might not reasonably expect a dispatch audio scenario in every instance. Although the device is capable of dispatch services, such dispatch service can be unavailable or limited in many occasions. For example, numerous factors such as User Setting, User Provisioning, and System Status can limit the practical use of the dispatch function of such a device. More specifically, the device can be in a Phone (or Interconnect) Only Setting or Call Filtering Settings in an iDEN device might limit use of dispatch services. Alternatively, the device can have it communicated that the device has not been provisioned on the current system for dispatch. Or, the phone may be out of service and not reasonably expect any incoming or outgoing call.

When the device 10 identifies the case when dispatch audio cannot occur, then the device determines the next most critical timing. In this example, the next most critical timing can be Interconnect Audio or cellular audio. The time delay acceptable to the user might be 600 millisecs. Subtracting the 200 millisecs for determination and reconnection (described in detail above), then the maximum period is fixed at 400 millisecs (2× that of dispatch audio period). An out-of-service or no service condition is yet another example. In that case, the most critical timing occurs with key presses. Assuming the user will accept loss of audio feedback for limited times, the timing window may be extended as far as 1000 millisecs. The period of checking on the connection can then be 800 millisecs (4× that of the dispatch audio). Using the dynamic adjustment techniques can result is a device that will transmit less often and save more power. As noted before, although audio connection scenarios for longer range wireless connections probably provide the clearest examples of critical timing, embodiments of the present invention can be applied to other devices beyond audio and phone services that have varying critical timing requirements and a short range wireless connection. A long range wireless connection is not necessarily required for numerous embodiments in accordance with the present invention.

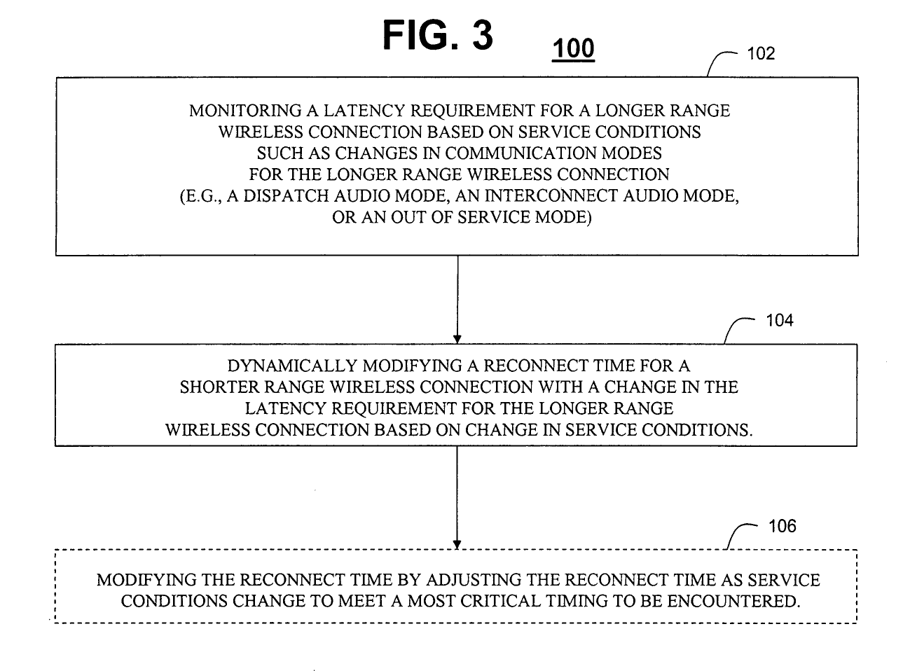

Referring to FIG. 3, a method 100 of dynamic power savings for a shorter range wireless connection based on service conditions for a longer range wireless connection can include the step 102 of monitoring a latency requirement for the longer range wireless connection based on service conditions and the step 104 of dynamically modifying a reconnect time for the shorter range wireless connection with a change in the latency requirement for the longer range wireless connection based on change in service conditions. The latency requirement for the longer range wireless connection can be based on changes in communication modes for the longer range wireless connection. The communication modes can be a dispatch audio mode, an interconnect audio mode, or an out of service mode for example. The step of dynamically modifying the reconnect time can optionally include adjusting the reconnect time as service conditions change to meet a most critical timing to be encountered at step 106.

In light of the foregoing description, it should be recognized that embodiments in accordance with the present invention can be realized in hardware, software, or a combination of hardware and software. A network or system according to the present invention can be realized in a centralized fashion in one computer system or processor, or in a distributed fashion where different elements are spread across several interconnected computer systems or processors (such as a microprocessor and a DSP). Any kind of computer system, or other apparatus adapted for carrying out the functions described herein, is suited. A typical combination of hardware and software could be a general purpose computer system with a computer program that, when being loaded and executed, controls the computer system such that it carries out the functions described herein.

In light of the foregoing description, it should also be recognized that embodiments in accordance with the present invention can be realized in numerous configurations contemplated to be within the scope and spirit of the claims. Additionally, the description above is intended by way of example only and is not intended to limit the present invention in any way, except as set forth in the following claims.

What is claimed is:

1. A method of dynamic power savings for a shorter range wireless connection based on service conditions for a longer range wireless connection, comprising the steps of:
monitoring a latency requirement for the longer range wireless connection based on service conditions; and
dynamically modifying a reconnect time for the shorter range wireless connection with a change in the latency requirement for the longer range wireless connection based on change in service conditions.

2. The method of claim 1, wherein the step of monitoring the latency requirement for the longer range wireless connection is based on changes in communication modes for the longer range wireless connection.

3. The method of claim 2, wherein the communication modes is selected among the group comprising a dispatch audio mode, an interconnect audio mode, and an out of service mode.

4. The method of claim 1, wherein the step of dynamically modifying the reconnect time comprises adjusting the reconnect time as service conditions change to meet a most critical timing to be encountered.

5. A system for dynamic power savings for a communication device having a shorter range wireless connection and a longer range wireless connection based on service conditions for the longer range wireless connection, comprising:
a transceiver for at least one among the shorter range wireless connection and the longer range wireless connection;
a processor coupled to the transceiver, wherein the processor is programmed to:
monitor a latency requirement for the longer range wireless connection based on service conditions; and
dynamically modify a reconnect time for the shorter range wireless connection with a change in the latency requirement for the longer range wireless connection based on change in service conditions.

6. The system of claim 5, wherein the processor monitors the latency requirement for the longer range wireless connection based on changes in communication modes for the longer range wireless connection.

7. The system of claim 6, wherein the communication modes is selected among the group comprising a dispatch audio mode, an interconnect audio mode, and an out of service mode.

8. The system of claim 5, wherein the processor dynamically modifies the reconnect time by adjusting the reconnect time as service conditions change to meet a most critical timing to be encountered by the longer range wireless connection.

9. The system of claim 5, wherein the shorter range wireless connection is selected among the group comprising Bluetooth, 802.11a-g, and wireless local area networks.

10. The system of claim 5, wherein the longer range wireless connection is selected among the systems comprising two-way messaging systems, cellular radio systems, satellite communication systems, dispatch radio systems, and two-way trunked radio systems.

11. A system for dynamic power savings for a portable electronic device having a wireless connection to a second electronic device, comprising:
a first transceiver in the portable electronic device in communication with a second transceiver in the second electronic device;
a processor coupled to the first transceiver, wherein the processor is programmed to
monitor a latency requirement in the second device corresponding to an expectation of needing a future data link between the portable electronic device and the second electronic device; and
dynamically modify a reconnect time between the portable electronic device and the second electronic device with a change in the latency requirement for the second electronic device based on a change in application status at the second electronic device.

12. The system of claim 11, wherein the processor monitors the latency requirement for the second electronic device based on changes in application status such as communication modes for the second electronic device.

13. The system of claim 12, wherein the communication modes is selected among the group comprising a dispatch audio mode, an interconnect audio mode, and an out of service mode.

14. The system of claim 11, wherein the change in application status further comprises a change from having no applications open to having at least one application open at the second electronic device.

15. The system of claim 1 1, wherein the change in application status further comprises a change from having one application active with a first latency requirement to having another application active with a second latency requirement at the second electronic device.

16. The system of claim 1 1, wherein the processor dynamically modifies the reconnect time by adjusting the reconnect time as service conditions change to meet a most critical timing to be encountered by the second electronic device.

17. The system of claim 11, wherein the portable electronic device is selected among the group comprising a Bluetooth transceiver, 802.11a-g based transceiver, and a wireless local area network transceiver.

18. The system of claim 11, wherein the second electronic device is selected among the group of electronic devices comprising a two-way messaging device, a cellular radio device, a satellite communication device, a dispatch radio device, and a two-way trunked radio device.

19. The system of claim 11, wherein the second electronic device is selected from the group comprising a laptop computer, a desktop computer, a personal digital assistant, a copier, a printer, a facsimile machine, and a wired telephone, and a television tuner.
